(19) United States
(12) Patent Application Publication
(10) Pub. No.: US 2024/0202522 A1
(43) Pub. Date: Jun. 20, 2024

(54) DEVICE AND METHOD FOR GENERATING DEEP LEARNING MODEL GRAPH AND ABSTRACT SYNTAX TREE FOR INTEGRATED COMPILER

(71) Applicant: Electronics and Telecommunications Research Institute, Daejeon (KR)

(72) Inventor: Hyunjeong KWON, Daejeon (KR)

(73) Assignee: Electronics and Telecommunications Research Institute, Daejeon (KR)

(21) Appl. No.: 18/544,910

(22) Filed: Dec. 19, 2023

(30) Foreign Application Priority Data
Dec. 19, 2022 (KR) 10-2022-0178720
Mar. 30, 2023 (KR) 10-2023-0042202

(51) Int. Cl. G06N 3/08

(52) U.S. Cl. CPC G06N 3/08

(57) ABSTRACT

Provided are a device and method for generating a deep learning model graph and an abstract syntax tree (AST) for an integrated compiler. The method includes: generating, by a processor, a forward graph for inference of a deep learning model and a backward graph for training the deep learning model through a graph generator using the same library according to the same grammatical structure; and generating, by the processor, an AST for the forward graph and the backward graph using one parser.

### CROSS-REFERENCE TO RELATED APPLICATION

The present application claims priority under 35 U.S.C. § 119(a) to Korean Application No. 10-2022-0178720, filed on Dec. 19, 2022 in the Korean Intellectual Property Office and Korean Application No. 10-2023-0042202 filed on Mar. 30, 2023 in the Korean Intellectual Property Office, which are hereby incorporated by reference for all purposes as if set forth herein.

### BACKGROUND

### 1. Field of the Invention

The present invention relates to a device and method for generating a deep learning model graph and an abstract syntax tree (AST) for an integrated compiler, and more particularly, to a device and method for generating a deep learning model graph and an AST for an integrated compiler that allow generation of a backward graph having the same grammatical structure as a forward graph.

### 2. Discussion of Related Art

In general, after a deep learning model is graphed, the graph is parsed and converted into a data structure that is understood by a compiler and compiled to generate accelerator machine code.

Meanwhile, deep learning model inference requires generation of a forward graph, and deep learning model training requires generation of a backward graph in addition to generation of a forward graph.

Here, when a framework for deep learning model development is PyTorch, a forward graph may be output in the form of text according to a predefined grammatical structure using a library called TorchScript which is an intermediate representation of a PyTorch model.

On the other hand, there is no library that outputs a backward graph in the form of text. In particular, there is no library that outputs a backward graph using the grammatical structure of a forward graph.

Accordingly, it is difficult to convert a backward graph of a deep learning model into a data structure that is understood by a compiler, and as a result, it is not easy to generate accelerator machine code.

For example, compilers of existing deep learning models are limited in supporting training.

TVM of Apache, nGraph of Intel, XLA of Google, Glow of Meta, and the like have problems in that a training system for only specific hardware is provided, only TensorFlow is supported, or training of only a limited number of specific models is supported.

### SUMMARY OF THE INVENTION

The present invention is directed to providing a device and method for generating a deep learning model graph and an abstract syntax tree (AST) for an integrated compiler that allow generation of a backward graph having the same grammatical structure as a forward graph.

According to an aspect of the present invention, there is provided a method of generating a deep learning model graph and an AST for an integrated compiler, the method including: generating, by a processor, a forward graph for inference of a deep learning model and a backward graph for training the deep learning model through a graph generator using the same library according to the same grammatical structure; and generating, by the processor, an AST for the forward graph and the backward graph using one parser.

The generating of the backward graph using the same library according to the same grammatical structure may include extracting, by the processor, all trainable nodes among nodes in the deep learning model and edge information for connecting the nodes and then outputting the nodes and the edge information as input data for graph generation.

The method may further include, after the extracting of the all the trainable nodes and the edge information for connecting the nodes: determining, by the processor, types of all the nodes from a first node; and storing only node information or the node information and attribute information in a memory depending on a determined type of a node.

The storing of only the node information or the node information and the attribute information in the memory may include: determining, by the processor, a type of current node; storing only node information in the memory when the current node is a leaf node; and storing not only the node information but also attribute information in the memory when the current node is not a leaf node.

The method may further include, after the storing of only the node information or the node information and the attribute information in the memory, outputting, by the processor, the nodes stored in the memory and connection states between the nodes.

The method may further include, after the outputting of the nodes stored in the memory and the connection states between the nodes, outputting, by the processor, actual values of the attribute information of the nodes stored in the memory.

The generating of the AST for the forward graph and the backward graph may include: reading, by the processor, syntax representing a start portion of an input graph according to the grammatical structure to generate a FunctionAST; reading syntax representing a graph name to generate a PrototypeAST; and reading syntax representing an actual structure of the backward graph and information required for calculation to sequentially generate a list in an ExprAST which is a body portion of the FunctionAST.

The method may further include, after the generation of the PrototypeAST, extracting, by the processor, a name and a data type of an input node according to the grammatical structure and adding the extracted name and data type as information on the graph name to the PrototypeAST.

The sequential generation of the list in the ExprAST which is the body portion of the FunctionAST may include sequentially generating, by the processor, the list in the ExprAST according to the grammatical structure on the basis of syntax starting with a specified keyword and information included in the syntax.

According to information included in AST nodes, the list in the ExprAST may include at least nine AST nodes, which may be a VarDeclAST representing a prototype of a function, a ReturnAST representing a return value of a function, a TorchOpAST representing an operator, a NumberAST representing a constant, a ListAST representing a variable array, a CallAST representing operator information, a VariableAST representing a variable, a LiteralAST representing a constant array, and a TensorAST representing attribute information.

According to another aspect of the present invention, there is provided a device for generating a deep learning model graph and an AST for an integrated compiler, the device including: a graph generator of a processor configured to generate a forward graph for inference of a deep learning model and a backward graph for training the deep learning model using the same library according to the same grammatical structure; and a parser of the processor configured to generate an AST for the forward graph and the backward graph.

To generate the backward graph using the same library according to the same grammatical structure, the processor may extract all trainable nodes among nodes in the deep learning model and edge information for connecting the nodes and then output the nodes and the edge information as input data for graph generation.

After extracting the all the trainable nodes and the edge information for connecting the nodes, the processor may determine types of all the nodes from a first node and store only node information or the node information and attribute information in a memory depending on a determined type of a node.

The processor may determine a type of current node, store only node information in the memory when the current node is a leaf node, and store not only the node information but also attribute information in the memory when the current node is not a leaf node.

After storing only the node information or the node information and the attribute information in the memory, the processor may output the nodes stored in the memory and connection states between the nodes.

After outputting the nodes stored in the memory and the connection states between the nodes, the processor may output actual values of the attribute information of the nodes stored in the memory.

To generate the AST for the forward graph and the backward graph, the processor may generate a FunctionAST by reading syntax representing a start portion of an input graph according to the grammatical structure, generate a PrototypeAST by reading syntax representing a graph name, and sequentially generate a list in an ExprAST which is a body portion of the FunctionAST by reading syntax representing an actual structure of the backward graph and information required for calculation.

After generating the PrototypeAST, the processor may extract a name and a data type of an input node according to the grammatical structure and add the extracted name and data type as information on the graph name to the PrototypeAST.

The processor may sequentially generate the list in the ExprAST which is the body portion of the FunctionAST according to the grammatical structure on the basis of syntax starting with a specified keyword and information included in the syntax.

According to information included in AST nodes, the list in the ExprAST may include at least nine AST nodes, which may be a VarDeclAST representing a prototype of a function, a ReturnAST representing a return value of a function, a TorchOpAST representing an operator, a NumberAST representing a constant, a ListAST representing a variable array, a CallAST representing operator information, a VariableAST representing a variable, a LiteralAST representing a constant array, and a TensorAST representing attribute information.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic block diagram of a device for generating a deep learning model graph and an abstract syntax tree (AST) for an integrated compiler according to an exemplary embodiment of the present invention;

FIG. 2 is a flowchart illustrating a method of generating a backward graph according to an exemplary embodiment of the present invention;

FIG. 3 is an example view of results of performing operations S110 and S120;

FIG. 4 is a diagram illustrating terms required for understanding when performing operation S130;

FIG. 5 is an example view of results of performing operation S130 of FIG. 2 on the basis of definitions in FIG. 4; and

FIG. 6 is a diagram showing types of AST nodes required for generating an AST from a generated graph using a single parser.

### DETAILED DESCRIPTION OF EXEMPLARY EMBODIMENTS

Hereinafter, a device and method for generating a deep learning model graph and an abstract syntax tree (AST) for an integrated compiler according to exemplary embodiments of the present invention will be described with reference to the accompanying drawings. In this process, the thicknesses of lines, the sizes of components, and the like shown in the drawings may be exaggerated for the purpose of clarity and convenience of description. Also, terms to be described below are defined in consideration of functions in the present invention, and the terms may vary depending on the intention of a user or operator or precedents. Therefore, the definitions of these terms are to be made on the basis of the overall content of the specification.

In the case of outputting a forward graph and a backward graph using the same library according to the same grammatical structure, the present invention makes it possible to generate an AST for the forward graph and the backward graph using a single parser, and the AST can be input to a deep learning model compiler. Therefore, the deep learning model compiler can be simplified, and deep learning model development can be facilitated.

Consequently, according to the present invention, an output grammar structure of a backward graph is defined the same as a grammatical structure applied to a forward graph using any one library (e.g., TorchScript), and a data structure representing the types of nodes and the connection states of the nodes is output on the basis of the grammatical structure. Accordingly, an AST for the forward graph and the backward graph can be generated using a single parser and input to a deep learning model compiler. As a result, it is possible to simplify a structure of the deep learning model compiler and facilitate deep learning model development.

This will be described in further detail below.

As described above, a forward graph for deep learning model inference in the present invention may be directly output using information (e.g., inlined_graph information) specified for a library package of a specified framework. However, the present invention is not limited thereto.

On the other hand, in the case of a backward graph for deep learning model training, there is no library for outputting the graph in the form of text, particularly, there is no library for outputting the backward graph in the form of text using the same grammatical structure as a forward graph.

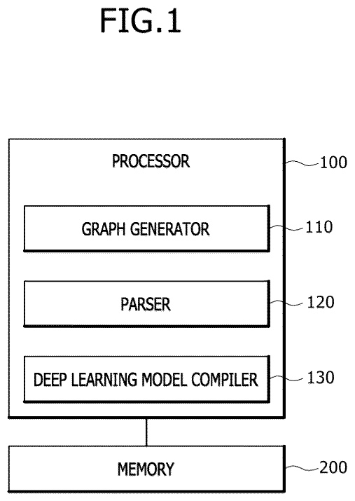

Accordingly, the present invention provides a method of generating (outputting) a backward graph in the form of text with the same grammatical structure as a forward graph (see FIG. 1). To this end, information (e.g., grad_fn, next_functions, and variables) on an automatic differentiation package (e.g., autograd of PyTorch) of a specified framework may be used. However, the present invention is not limited thereto.

For reference, “grad_fn” is information including backward function information for calculating a gradient, and “next_functions” is one list. The number of elements in the list is the number of training parameters of which gradients are to be calculated by the function, and each element is the subsequent backward function to which a corresponding trainable parameter is connected. “Variable” has information about whether a current node is a leaf node that does not have any connection node.

In this way, according to the present invention, a backward graph is output in the form of text using a grammatical structure which is used for outputting a forward graph, and an AST can be generated using a single parser and input to an integrated compiler of a deep learning model for forward graphs and backward graphs.

FIG. 1 is a schematic block diagram of a device for generating a deep learning model graph and an AST for an integrated compiler according to an exemplary embodiment of the present invention.

Referring to FIG. 1, a processor 100 may include a graph generator 110, a parser 120, and a deep learning model compiler 130, which may represent different functions performed by the processor 100 according to control instructions provided by program code.

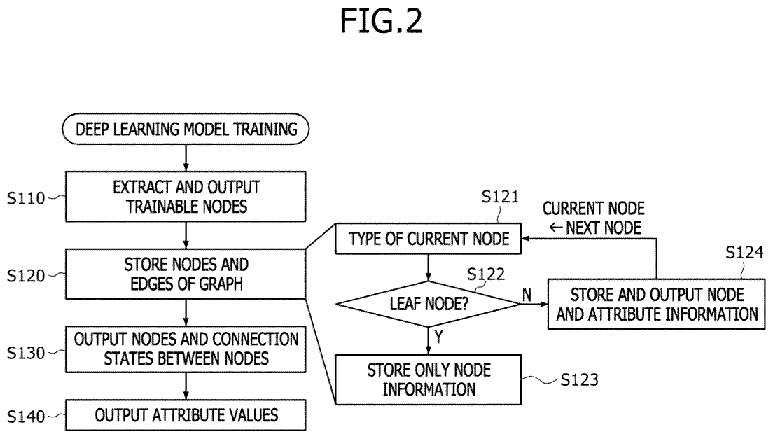

The processor 100 and the graph generator 110 thereof may generate a graph of a deep learning model for an integrated compiler by performing operations S110 to S140 included in a method illustrated in FIG. 2.

Also, the processor 100 and the parser 120 thereof may generate an AST for a forward graph and a backward graph by reading the graph of the deep learning model for an integrated compiler and input the AST to the deep learning model compiler 130.

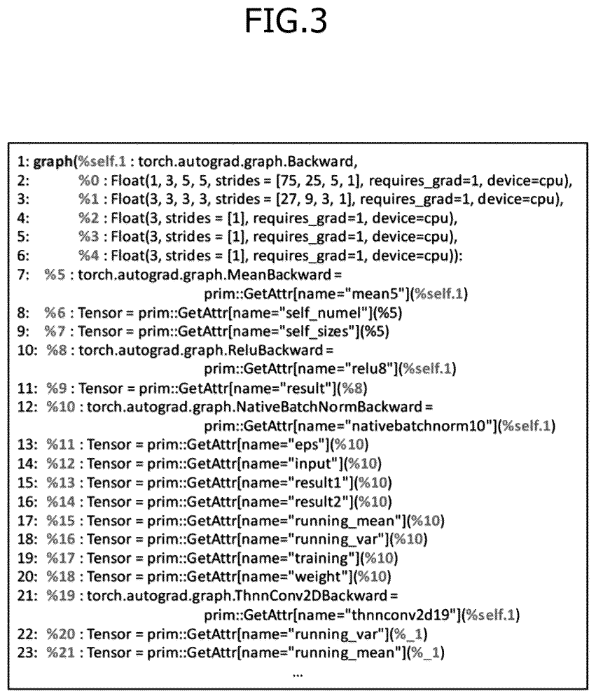

Operations of the parser 120 will be described in further detail with reference to FIGS. 3, 5, and 6.

The processor 100 and the components 110 to 130 thereof may be implemented to execute instructions according to code of an operating system (OS) and code of at least one program included in a memory 200.

FIG. 2 is a flowchart illustrating a method of generating a backward graph according to an exemplary embodiment of the present invention.

Referring to FIG. 2, the processor 100 extracts all trainable nodes among nodes in a deep learning model and edge information for connecting the nodes and then outputs the nodes and the edge information as input data for graph generation (S110).

Accordingly, it is possible to know information on all inputs and outputs of a graph to be generated.

For example, with regard to all nodes from the first node, the processor 100 determines the type of node and stores only node information or the node information and attribute information in the memory 200 depending on the determined type of node.

More specifically, the processor 100 determines a type of current node (S121) and stores only node information (S123) when the current node is a leaf node (i.e., a node that does not have any subsequent node connected through an edge) (Y in S122).

When the current node is not a leaf node (N in S122), it is necessary to additionally perform backpropagation. Accordingly, the processor 100 stores the current node information and attribute information (e.g., attribute information beginning with “saved”) together in the memory 200 and outputs the current node information and the attribute information together (S124).

The same process (i.e., a process of setting a subsequent node as a current node, determining a type of set current node, and storing only node information or the node information and attribute information in the memory depending on the determined type) is performed again for the subsequent node connected to the current node (S121 to S124).

The processor 100 outputs nodes which are stored in operation S120 and connection states between the nodes (S130).

Accordingly, it is possible to know the structure of the graph.

The processor 100 outputs actual values of the attribute information stored in operation S120 (i.e., actual attribute values) (S140).

Accordingly, it is possible to know actual values that are required for calculating gradients of the nodes.

FIG. 3 is an example view of results of performing operations S110 and S120.

In FIG. 3, lines 1 to 6 represent output results after operation S110 is performed, and a graph name (e.g., graph) and trainable parameters (e.g., %self.1, %0, %1, %2, and the like) are all output in lines 1 to 6.

In FIG. 3, lines 7, 10, 12, and 21 represent node information output after operation S120 is performed, and other lines (e.g., lines other than lines 1 to 6 and lines 7, 10, 12, and 21) represent attribute information of the nodes.

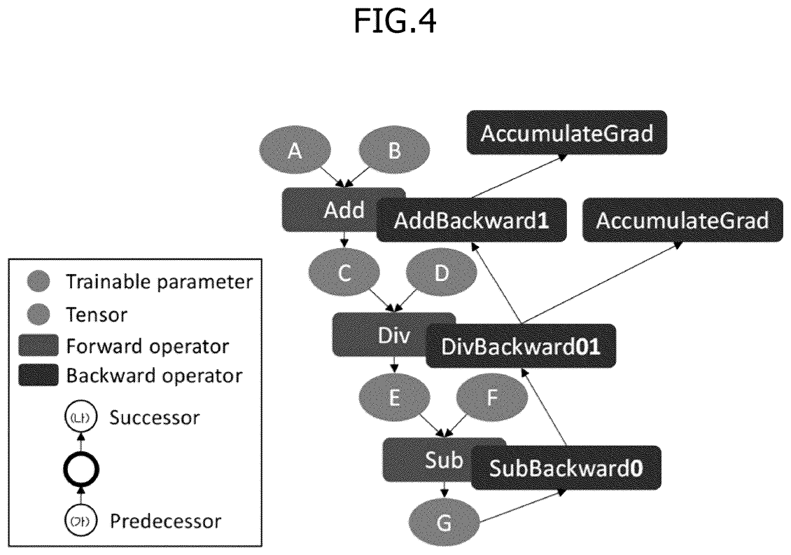

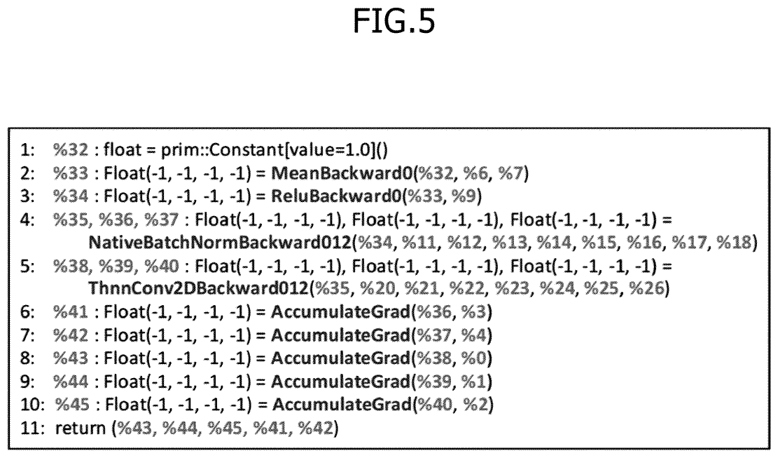

FIG. 4 is a diagram illustrating terms required for understanding when performing operation S130, and FIG. 5 is an example view of results of performing operation S130 of FIG. 2 on the basis of definitions in FIG. 4.

Referring to FIG. 4, assuming that there is a connection from node A to node B, node A and node B in the present invention are referred to as a predecessor and a successor, respectively.

When operation S120 of FIG. 2 is performed, it is possible to know predecessor (i.e., node A) and successor (i.e., node B) information of all nodes. The information on predecessor nodes and successor nodes is used for outputting connections in a graph.

First, it is possible to know the source of a gradient propagated from a predecessor of a specific node to the node.

Therefore, when a node is connected to a single predecessor, a single gradient is propagated without any change. When a node is connected to a plurality of predecessors, an add function for adding a plurality of propagated gradients is added to output and propagate an added gradient.

Also, it is possible to know to which node a gradient will be transferred from a successor of a specific node and which variable number of the corresponding node is trainable.

Therefore, according to the present invention, a node name is displayed with not only a node type but also an index defined according to which variable number is trainable.

In other words, a node name of a backward graph is recorded in the form of “SubBackward0” or the like, and the node name includes a node type (e.g., SubBackward, DivBackward, or AddBackward) and an index (e.g., 0, 01, or 1).

Here, the index is determined and displayed depending on which variable number (e.g., (A or B between A and B), (C or D between C and D), (E or F between E and F), and G) is trainable among input variables (e.g., (A, B), (C, D), (E, F), and G).

For example, in FIG. 4, a node SubBackward has a first input variable as a trainable variable, and thus the first input variable is displayed with an index of 0. A node DivBackward has all input variables as trainable variables, and thus all the input variables are displayed with an index of 01. A node AddBackward has a second input variable as a trainable variable, and thus the second input variable is displayed with an index of 1.

FIG. 5 is an example view of results of performing operation S130 of FIG. 2 on the basis of the definitions in FIG. 4. Referring to FIG. 5, a backward graph starts with an initial gradient of 1.0 (e.g., value=1.0). This value is transferred as a first input of each backward node and propagated to an entire graph through edges and nodes.

For example, in FIG. 5, %32 in which the initial gradient value is stored is transferred through a first input of a node MeanBackward0 which is a first node. The received gradient is updated through a gradient calculation process of the node MeanBackward0 and output as %33. The propagation result %33 is transferred through a first input of a node ReluBackward0 which is the subsequent node and likewise propagated through a gradient calculation process as %34. Here, inputs other than the first inputs are attributes required for the calculation.

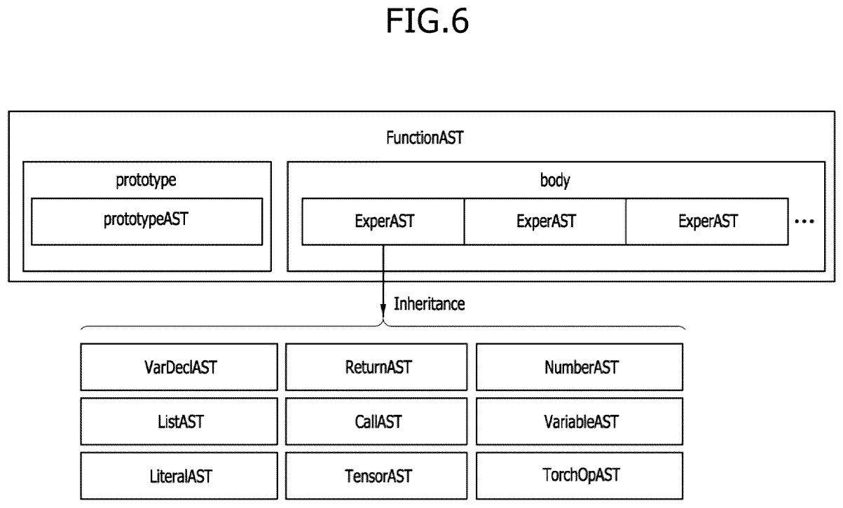

Meanwhile, when a graph is generated according to the method of the flowchart illustrated in FIG. 2, the processor 100 generates an AST through the parser 120 (see FIG. 6).

More specifically, the parser 120 reads “graph” of FIG. 3 which is a start portion of the input graph and generates a FunctionAST.

After that, the parser 120 reads %self.1 to recognize that %self.1 is a graph name, generates a PrototypeAST, and then adds information on the name. Until a colon (“:” in line 6 of FIG. 3) is read, the parser 120 recognizes that corresponding content is information on inputs of the graph, extracts the name of an input node (e.g., %0) and a data type (Float and shape information (1, 3, 5, 5)), and adds the extracted information to the PrototypeAST.

Line 7 and below of FIG. 3 and lines of FIG. 5 include the structure of an actual backward graph and information required for calculation. Accordingly, the parser 120 subsequently reads the corresponding portion and generates a list in an ExprAST which is the body portion of the FunctionAST,

For example, when the keyword “torch” is behind a name beginning with % as shown in line 7 of FIG. 3, a node type and name are included. In this case, a “TorchOpAST” is generated, and then the information is stored.

When the keyword “Tensor” is behind a name beginning with % as shown in line 8 of FIG. 3, this represents an attribute required for calculation. In this case, a “TensorAST” is generated, and then the information is stored.

When the keyword “float” is behind a name beginning with % as shown in line 1 of FIG. 5, this represents a node having a specific value. In this case, the value generates a “NumberAST” and then stores the information, and the “NumberAst” and a node name (%32) generate a “VarDeclAST” and then store the information.

When the keyword “Float” is behind a name beginning with % as shown in line 2 of FIG. 5, this includes a calculation node (MeanBackward0) and information on inputs (%32, %6, and %7) required for calculation. In this case, each of the inputs required for calculation generates a “VariableAST” and then stores a name, and a “CallAST” is generated using nodes of the generated “VariableAST” and the name of the calculation node.

As described above, the parser is designed to read all portions of the graph, analyze the meanings, generate an AST by generating AST nodes, and then transfer the ASTs to a deep learning compiler.

For reference, FIG. 6 is a diagram showing types of AST nodes required for generating an AST from a generated graph using the single parser 120. In FIG. 6, a PrototypeAST includes an input node and a graph name, and an ExprAST includes information on other portions (e.g., information on a calculation-related portion of FIG. 3 other than lines 1 to 6). The ExprAST is divided into nine nodes (e.g., a VarDeclAST, a ReturnAST, a NumberAST, a ListAST, a CallAST, a VariableAST, a LiteralAST, a TensorAST, and a TorchOpAST) according to the types of included information.

Here, the VarDeclAST represents a prototype of a function (the name of the function and an input node), the ReturnAST represents a return value of a function (a return node), the TorchOpAST represents a PyTorch operator (an operator name and an output node name), the

NumberAST represents a constant (a constant value), the ListAST represents a variable array (a list of variables), the CallAST represents operator information (an operator name and attributes required for calculation), the VariableAST represents a variable (a variable name), the LiteralAST represents a constant array (a list of constants and the shape of the array), and the TensorAST represents attributes (attribute names, an output node name, and values).

According to the present invention, it is possible to generate a backward graph having the same grammatical structure as a forward graph, and thus an integrated compiler employing a single parser can be used.

Although the present invention has been described above with reference to embodiments illustrated in the drawings, the embodiments are merely illustrative, and those skilled in the art should understand that various modifications and other equivalent embodiments can be made from the embodiments. Therefore, the technical scope of the present invention should be determined from the following claims. Also, the implementations described herein may be embodied as, for example, a method, a process, a device, a software program, a data stream, or signals. Even in the case where the present invention has been discussed in the context of a single form of implementation (e.g., only discussed as a method), the discussed features may also be realized in another form (e.g., a device or a program). The device may be implemented as suitable hardware, software, firmware, or the like. The method may be realized in a device, such as a processor, typically referred to as a processing device including, for example, a computer, a microprocessor, an integrated circuit, a programmable logic device, or the like.

What is claimed is:

1. A method of generating a deep learning model graph and an abstract syntax tree (AST) for an integrated compiler, the method comprising:
generating, by a processor, a forward graph for inference of a deep learning model and a backward graph for training the deep learning model through a graph generator using the same library according to the same grammatical structure; and
generating, by the processor, an AST for the forward graph and the backward graph using one parser.

2. The method of claim 1, wherein the generating of the backward graph using the same library according to the same grammatical structure comprises extracting, by the processor, all trainable nodes among nodes in the deep learning model and edge information for connecting the nodes and then outputting the nodes and the edge information as input data for graph generation.

3. The method of claim 2, further comprising, after the extracting of the all the trainable nodes and the edge information for connecting the nodes:
determining, by the processor, types of all the nodes from a first node; and
storing only node information or the node information and attribute information in a memory depending on a determined type of a node.

4. The method of claim 3, wherein the storing of only the node information or the node information and the attribute information in the memory comprises:
determining, by the processor, a type of current node;
storing only node information in the memory when the current node is a leaf node; and
storing not only the node information but also attribute information in the memory when the current node is not a leaf node.

5. The method of claim 3, further comprising, after the storing of only the node information or the node information and the attribute information in the memory, outputting, by the processor, the nodes stored in the memory and connection states between the nodes.

6. The method of claim 5, further comprising, after the outputting of the nodes stored in the memory and the connection states between the nodes, outputting, by the processor, actual values of the attribute information of the nodes stored in the memory.

7. The method of claim 1, wherein the generating of the AST for the forward graph and the backward graph comprises:
reading, by the processor, syntax representing a start portion of an input graph according to the grammatical structure to generate a FunctionAST;
reading syntax representing a graph name to generate a PrototypeAST; and
reading syntax representing an actual structure of the backward graph and information required for calculation to sequentially generate a list in an ExprAST which is a body portion of the FunctionAST.

8. The method of claim 7, further comprising, after the generation of the PrototypeAST, extracting, by the processor, a name and a data type of an input node according to the grammatical structure and adding the extracted name and data type as information on the graph name to the PrototypeAST.

9. The method of claim 7, wherein the sequential generation of the list in the ExprAST which is the body portion of the FunctionAST comprises sequentially generating, by the processor, the list in the ExprAST according to the grammatical structure on the basis of syntax starting with a specified keyword and information included in the syntax.

10. The method of claim 7, wherein, according to information included in AST nodes, the list in the ExprAST includes at least nine AST nodes, which are a VarDeclAST representing a prototype of a function, a ReturnAST representing a return value of a function, a TorchOpAST representing an operator, a NumberAST representing a constant, a ListAST representing a variable array, a CallAST representing operator information, a VariableAST representing a variable, a LiteralAST representing a constant array, and a TensorAST representing attribute information.

11. A device for generating a deep learning model graph and an abstract syntax tree (AST) for an integrated compiler, the device comprising:
a graph generator of a processor configured to generate a forward graph for inference of a deep learning model and a backward graph for training the deep learning model using the same library according to the same grammatical structure; and
a parser of the processor configured to generate an AST for the forward graph and the backward graph.

12. The device of claim 11, wherein, to generate the backward graph using the same library according to the same grammatical structure, the processor extracts all trainable nodes among nodes in the deep learning model and edge information for connecting the nodes and then outputs the nodes and the edge information as input data for graph generation.

13. The device of claim 12, wherein, after extracting the all the trainable nodes and the edge information for connecting the nodes, the processor determines types of all the nodes from a first node and stores only node information or the node information and attribute information in a memory depending on a determined type of a node.

14. The device of claim 13, wherein the processor determines a type of current node, stores only node information in the memory when the current node is a leaf node, and stores not only the node information but also attribute information in the memory when the current node is not a leaf node.

15. The device of claim 13, wherein, after storing only the node information or the node information and the attribute information in the memory, the processor outputs the nodes stored in the memory and connection states between the nodes.

16. The device of claim 15, wherein, after outputting the nodes stored in the memory and the connection states between the nodes, the processor outputs actual values of the attribute information of the nodes stored in the memory.

17. The device of claim 11, wherein, to generate the AST for the forward graph and the backward graph, the processor generates a FunctionAST by reading syntax representing a start portion of an input graph according to the grammatical structure, generates a PrototypeAST by reading syntax representing a graph name, and sequentially generates a list in an ExprAST which is a body portion of the FunctionAST by reading syntax representing an actual structure of the backward graph and information required for calculation.

18. The device of claim 17, wherein, after generating the PrototypeAST, the processor extracts a name and a data type of an input node according to the grammatical structure and adds the extracted name and data type as information on the graph name to the PrototypeAST.

19. The device of claim 17, wherein the processor sequentially generates the list in the ExprAST which is the body portion of the FunctionAST according to the grammatical structure on the basis of syntax starting with a specified keyword and information included in the syntax.

20. The device of claim 17, wherein, according to information included in AST nodes, the list in the ExprAST includes at least nine AST nodes, which are a VarDeclAST representing a prototype of a function, a ReturnAST representing a return value of a function, a TorchOpAST representing an operator, a NumberAST representing a constant, a ListAST representing a variable array, a CallAST representing operator information, a VariableAST representing a variable, a LiteralAST representing a constant array, and a TensorAST representing attribute information.
